(19) United States
(12) Patent Application Publication
(10) Pub. No.: US 2015/0219026 A1
(43) Pub. Date: Aug. 6, 2015

(54) IN-CYLINDER PRESSURE DETECTION DEVICE FOR INTERNAL COMBUSTION ENGINE

(71) Applicant: Shigeyuki Urano, Gotenba-shi (JP)

(72) Inventor: Shigeyuki Urano, Gotenba-shi (JP)

(73) Assignee: TOYOTA JIDOSHA KABUSHIKI KAISHA, Toyota-shi, Aichi-ken (JP)

(21) Appl. No.: 14/420,075

(22) PCT Filed: Sep. 24, 2013
(86) PCT No.: PCT/JP2013/075677

§ 371 Date: Feb. 6, 2015

(30) Foreign Application Priority Data
Oct. 16, 2012 (JP) 2012-229108

(51) Int. Cl. F02D 41/00; F02D 15/02

(52) U.S. Cl. CPC F02D 41/009; F02D 15/02

(57) ABSTRACT

This invention determines whether or not an internal combustion engine is performing combustion, and if the determined result is that the engine is not performing combustion, it is determined whether or not the engine revolution speed is greater than a predetermined revolution speed NEₜₕ. If it is found that the relation that the revolution speed>predetermined revolution speed NEₜₕ holds, an in-cylinder maximum pressure value Pₘₐₓ during motoring is identified by an in-cylinder pressure sensor 34, a crank angle θ_{Pmax} corresponding to the relevant Pₘₐₓ is detected by a crank angle sensor 42, and the crank angle is corrected so that θ_{Pmax} becomes TDC. Further, the crank angle correction amount is learned, and the relation between the signal of the crank angle sensor 42 and the actual crank angle (measured value) corresponding thereto is corrected.

### TECHNICAL FIELD

The present invention relates to an in-cylinder pressure detection device for an internal combustion engine, and more specifically to an in-cylinder pressure detection device that detects an in-cylinder pressure of an internal combustion engine using an in-cylinder pressure sensor.

### BACKGROUND ART

Technology has already been disclosed that corrects a detection error with respect to a reference crank angle position and exactly detects a maximum pressure angle from the relevant reference crank angle position to a position at which an in-cylinder pressure becomes the maximum pressure, as discussed, for example, in Japanese Patent Laid-Open No. 63-9679. According to this technology, more specifically, the in-cylinder pressure of the internal combustion engine during motoring is detected, and a position at which the maximum pressure value thereof occurs is detected as the actual top dead center position of the engine piston. Further, the reference crank angle position is corrected in accordance with the relevant actual top dead center position information, and the maximum pressure angle is determined based on the corrected reference crank angle position.

### CITATION LIST

### Patent Literature

### Patent Literature 1

Japanese Patent Laid-Open No. 63-9679

### Patent Literature 2

Japanese Patent Laid-Open No. 2010-236534

### SUMMARY OF INVENTION

### Technical Problem

According to the above described conventional technology, a position at which the maximum pressure value of the internal combustion engine occurs during motoring is detected as the actual top dead center position. However, compression leakage occurs from the compression stroke to the expansion stroke during motoring. Consequently, a deviation arises between the position at which the maximum pressure value occurs and the actual top dead center position. Further, in some cases the influence of an error that is caused by thermal strain or the like is superimposed on a pressure value detected by an in-cylinder pressure sensor.

Therefore, according to the conventional technology that detects a maximum pressure value during motoring using an in-cylinder pressure sensor, and detects the position at which the maximum pressure value occurs as being the actual top dead center position, there is a risk that the influence of an error may be superimposed on a detected value when detecting the actual top dead center position and it will therefore not be possible to accurately detect in-cylinder pressure information that corresponds to the actual crank angle.

The present invention has been made to solve the above described problems, and an object of the present invention is to provide an in-cylinder pressure detection device for an internal combustion engine that is capable of detecting in-cylinder pressure information that corresponds to an actual crank angle with high accuracy.

### Solution to Problem

To solve the above mentioned problem, a first aspect of the present invention is an in-cylinder pressure detection device for an internal combustion engine that includes an in-cylinder pressure sensor which is provided in a predetermined cylinder of the internal combustion engine and a crank angle sensor which outputs a signal which is synchronized with rotation of a crankshaft of the internal combustion engine, and that detects an in-cylinder pressure at a predetermined crank angle, comprising:

synchronization means for, in a case where an engine revolution speed is greater than a predetermined revolution speed at a time of motoring or a time of a fuel-cut operation of the internal combustion engine, synchronizing a crank angle with a signal of the crank angle sensor so that a crank angle corresponding to a signal of the crank angle sensor at a time point at which a maximum in-cylinder pressure is detected by the in-cylinder pressure sensor becomes a TDC.

A second aspect of the present invention is the in-cylinder pressure detection device for an internal combustion engine according to the first aspect, wherein the synchronization means includes means for setting the predetermined revolution speed to a progressively larger value as a charging efficiency of the internal combustion engine increases.

A third aspect of the present invention is the in-cylinder pressure detection device for an internal combustion engine according to the first aspect or the second aspect, further comprising:

determination means for determining whether or not an output deviation is occurring in a detection value of the in-cylinder pressure sensor; and

restriction means for, in a case where it is determined that the output deviation is occurring, restricting an operation by the synchronization means.

A fourth aspect of the present invention is the in-cylinder pressure detection device for an internal combustion engine according to the first aspect or the second aspect, further comprising:

determination means for determining whether or not an output deviation is occurring in a detection value of the in-cylinder pressure sensor; and

correction means for, in a case where it is determined that the output deviation is occurring, correcting the output deviation;

wherein the synchronization means acquires a signal of the crank angle sensor at a time point at which a maximum in-cylinder pressure is detected using an in-cylinder pressure after correction by the correction means.

A fifth aspect of the present invention is the in-cylinder pressure detection device for an internal combustion engine according to the third aspect or the fourth aspect, wherein the determination means includes means for, in a case where an absolute value of a heating value is less than a predetermined value, determining that the output deviation is not occurring.

### Advantageous Effects of Invention

According to the first aspect of the present invention, an in-cylinder pressure during motoring or during a fuel-cut operation is measured by an in-cylinder pressure sensor, and in order to make a crank angle that corresponds to a signal of a crank angle sensor at a position at which the in-cylinder pressure is the maximum pressure (hereunder, referred to as “reference signal”) the TDC, a value of the crank angle is synchronized with the signal of the crank angle sensor. At such time, acquisition of the reference signal is performed in a case where the revolution speed of the internal combustion engine is greater than a predetermined revolution speed. It is difficult for the influence of compression leakage in a cylinder to arise in a region in which the engine revolution speed is large. Therefore, according to the present aspect, since acquisition of a reference signal and a synchronization operation with respect to the crank angle are performed using an in-cylinder pressure detection value from which the influence of compression leakage has been removed to the utmost, in-cylinder pressure information corresponding to the crank angle can be detected with high accuracy.

According to the second aspect of the present invention, the higher that a charging efficiency (engine load) of the engine is, the larger the value to which a lower limit of the engine revolution speed that is a condition for acquiring a reference signal is set. The higher the charging efficiency of an engine is, the greater the compression leakage will be. Therefore, according to the present aspect, the higher that the charging efficiency of the engine is, the larger the value to which the lower limit of the engine revolution speed is set. Hence, even in a case where the charging efficiency is high, it is possible to limit the condition for acquiring a reference signal to a range in which the compression leakage is small.

According to the third aspect of the present invention, an operation to acquire a reference signal is restricted in a case where an output deviation occurs in an in-cylinder pressure detection value. Therefore, according to the present aspect, it is possible to effectively prevent the occurrence of a situation in which a synchronization operation with respect to the crank angle is performed using a reference signal on which the influence of an output deviation has been superimposed.

According to the fourth aspect of the present invention, in a case where an output deviation is occurring in an in-cylinder pressure detection value, a reference signal is acquired after the output deviation has been corrected. Therefore, according to the present aspect, since a synchronization operation with respect to the crank angle is performed using a reference signal from which the influence of an output deviation has been removed, in-cylinder pressure information corresponding to the crank angle can be detected with high accuracy.

According to the fifth aspect of the present invention, in a case where an absolute value of a heating value is less than a predetermined value, it is determined that an output deviation is not occurring. In a case where an output deviation is not occurring, a heating value transitions in the vicinity of 0, while in a case where an output deviation is occurring, the heating value transitions to a value that exceeds the vicinity of 0. Therefore, according to the present aspect, the existence or non-existence of the occurrence of an output deviation can be determined with high accuracy by comparing an absolute value of a heating value and a predetermined value.

### BRIEF DESCRIPTION OF DRAWINGS

FIG. 1 is a schematic configuration diagram for describing a system configuration as Embodiment 1 of the present invention.

FIG. 2 is a view illustrating an in-cylinder pressure change with respect to a crank angle during motoring.

FIG. 3 is a view for describing in detail the in-cylinder pressure change in the vicinity of TDC illustrated in FIG. 2.

FIG. 4 is a view illustrating deviation amounts from the actual TDC of Pₘₐₓ with respect to the engine revolution speed.

FIG. 5 is a view for describing an example of setting a predetermined revolution speed NEₜₕ in accordance with the size of the engine load.

FIG. 6 is a flowchart illustrating a routine that is executed in Embodiment 1 of the present invention.

FIG. 7 is a view illustrating a difference in in-cylinder pressure behavior that depends on the existence or non-existence of an output deviation.

FIG. 8 is a view illustrating heating value behavior that depends on the existence or non-existence of an output deviation.

FIG. 9 is a flowchart illustrating a routine that is executed in Embodiment 2 of the present invention.

FIG. 10 is a view for describing a method that corrects the influence of an output deviation.

### DESCRIPTION OF EMBODIMENTS

Hereunder, embodiments of the present invention are described based on the accompanying drawings. Note that elements that are common to the respective drawings are denoted by the same reference symbols, and a duplicate description thereof is omitted. Further, the present invention is not limited by the following embodiments.

### Embodiment 1

### Configuration of Embodiment 1

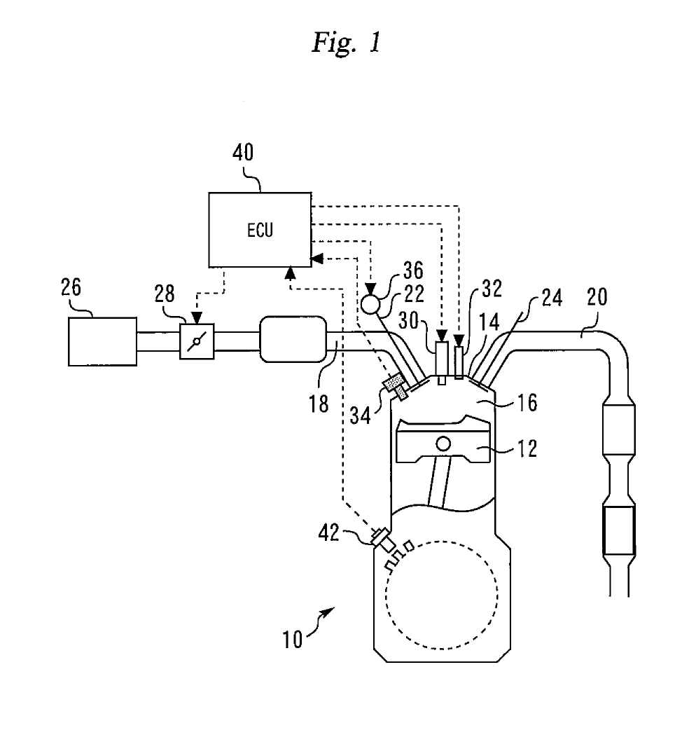

FIG. 1 is a schematic configuration diagram for describing a system configuration as Embodiment 1 of the present invention. As shown in FIG. 1, the system of the present embodiment includes an internal combustion engine 10. The internal combustion engine 10 is configured as a spark-ignition multi-cylinder engine that uses gasoline as a fuel. A piston 12 is provided inside each cylinder of the internal combustion engine 10, and performs a reciprocating motion in the respective cylinders. The internal combustion engine 10 also includes cylinder heads 14. A combustion chamber 16 is formed between each piston 12 and cylinder head 14. One end of each of an intake passage 18 and an exhaust passage 20 communicates with each combustion chamber 16. An intake valve 22 is arranged at a communication portion between the intake passage 18 and the combustion chamber 16. An exhaust valve 24 is arranged at a communication portion between the exhaust passage 20 and the combustion chamber 16.

An intake valve timing control device 36 that variably controls the valve timing is provided in the intake valve 22. In the present embodiment, it is assumed that a variable valve timing mechanism (VVT) that, by varying a phase angle of a camshaft (omitted from the drawing) with respect to a crankshaft, advances or retards the opening/closing timing while keeping the working angle constant is used as the intake valve timing control device 36.

An air cleaner 26 is mounted in an inlet of the intake passage 18. A throttle valve 28 is disposed downstream of the air cleaner 26. The throttle valve 28 is an electronically controlled valve that is driven by a throttle motor based on the degree of accelerator opening.

A spark plug 30 is mounted in the cylinder head 14 so as to protrude into the combustion chamber 16 from the top of the combustion chamber 16. A fuel injection valve 32 for injecting fuel into the cylinder is also provided in the cylinder head 14. Further, in-cylinder pressure sensors (CPS) 34 for detecting the in-cylinder pressure of each cylinder are incorporated into the respective cylinder heads 14.

As shown in FIG. 1, the system of the present embodiment includes an ECU (Electronic Control Unit) 40. In addition to the above described in-cylinder pressure sensor 34, various sensors such as a crank angle sensor 42 for detecting the rotational position of the crankshaft are connected to an input portion of the ECU 40. Further, various actuators such as the above described throttle valve 28, spark plug 30, and fuel injection valve 32 are connected to an output portion of the ECU 40. The ECU 40 controls the operating state of the internal combustion engine 10 based on various kinds of information that are input thereto.

### Operations of Embodiment 1

The in-cylinder pressure sensor (CPS) is an extremely useful sensor in the respect that the in-cylinder pressure sensor (CPS) can directly detect a combustion state inside a cylinder. Therefore, the output of the CPS is utilized as a control parameter for various kinds of control of the internal combustion engine. For example, the detected in-cylinder pressure is used to calculate an intake air amount that was drawn into the cylinder, to calculate fluctuations in the indicated torque and the like, and to calculate a heating value PV^{κ} or an MFB (mass fraction burned) or the like. These values are utilized to detect misfiring and for optimal ignition timing control and the like.

In order to use a signal acquired from the CPS in various kinds of control, it is necessary for the signal to be exactly synchronized with information regarding the actual crank angle. However, the in-cylinder pressure and the crank angle are information items that are linked by the ECU or the like after the in-cylinder pressure and the crank angle have been measured by respectively different sensors. Consequently, during the process from sensing of an analog signal of these sensors until storage of digital information, various temporal delays arise during low-pass filter (LPF) processing or AID conversion processing, and there is a risk that it will not be possible to accurately link the in-cylinder pressure information and the crank angle information.

As a method for solving the above described problem, a method (so-called “TDC correction”) is known that, using in-cylinder pressure information during motoring or during a fuel-cut operation (that is, at a time of engine driving in a state in which in-cylinder combustion is not being performed, that during motoring includes a time of fuel injection and at a time when fuel is not injected), corrects the relation between the actual crank angle and the crank angle signal that takes a timing at which the in-cylinder pressure becomes a maximum value as compression TDC. However, when TDC correction is performed while the vehicle is actual running, in some cases a phenomenon (compression leakage) arises whereby compressed air leaks out from a gap between a piston ring and a cylinder bore.

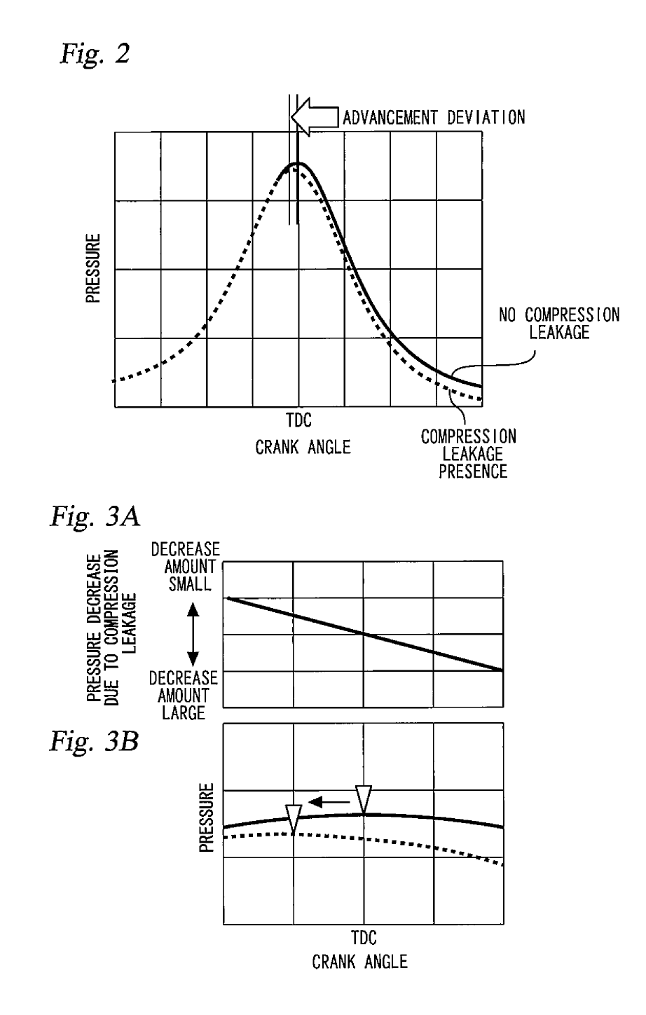

FIG. 2 is a view illustrating an in-cylinder pressure change with respect to the crank angle during motoring. As shown in FIG. 2, it is found that a crank angle corresponding to an in-cylinder maximum pressure value Pₘₐₓ in a case where there is compression leakage deviates to the advancement side in comparison to the crank angle corresponding to the value P^{max} in a case where there is no compression leakage (that is, the actual TDC). This fact will now be described in detail using FIGS. 3A and 3B. FIGS. 3A and 3B is a view for describing in detail the in-cylinder pressure change in the vicinity of TDC illustrated in FIG. 2. Note that, FIG. 3A is a view that illustrates a pressure decrease amount caused by compression leakage in the vicinity of TDC, and FIG. 3B is a view that illustrates a change in Pₘₐₓ that depends on the existence or non-existence of compression leakage.

Compression leakage proceeds with time in a region on a high pressure side. Consequently, as shown in FIG. 3A, a pressure decrease amount that is caused by compression leakage in the vicinity of TDC increases as the crank angle transitions to the retardation side. Accordingly, as shown in FIG. 3B, if the compression leakage illustrated in FIG. 3A arises in the vicinity of TDC with respect to which the pressure change is small, the crank angle corresponding to Pₘₐₓ deviates to the advancement side.

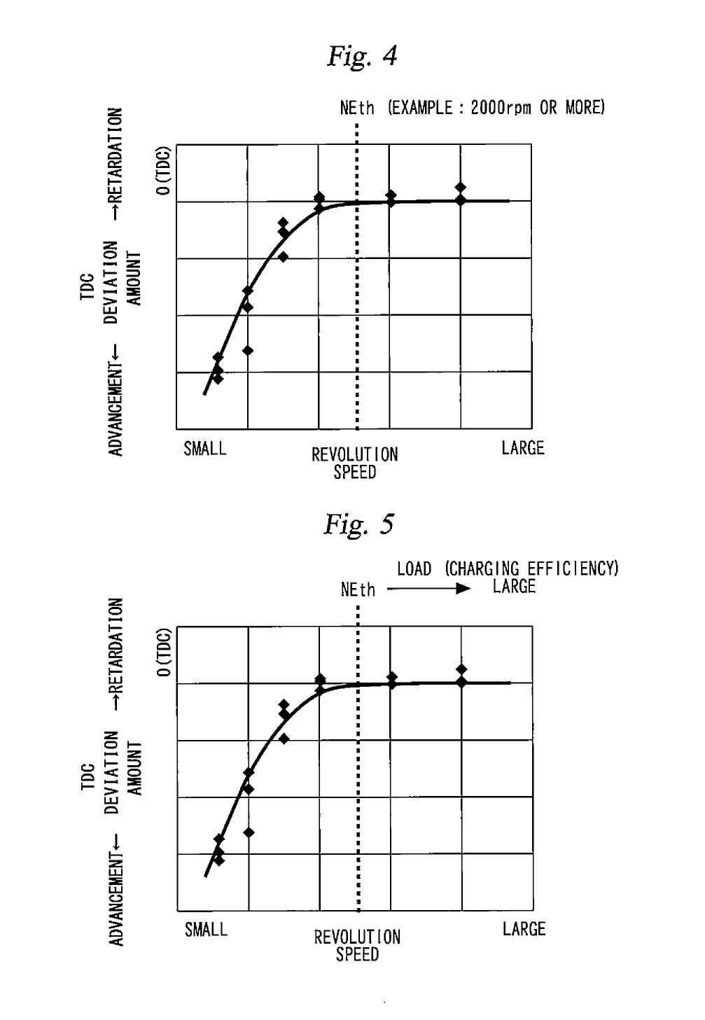

Further, the level of the compression leakage is related to the engine revolution speed. FIG. 4 is a view illustrating a deviation amount from the actual TDC of Pₘₐₓ with respect to the engine revolution speed. As described above, the compression leakage proceeds with time. Consequently, as shown in FIG. 4, the amount of deviation from the actual TDC of Pₘₐₓ increases in a region in which the engine revolution speed is low.

Thus, the deviation amount from the actual TDC of Pₘₐₓ during motoring varies according to the engine revolution speed. Therefore, in the present embodiment, a configuration is adopted that performs TDC correction in a case where the engine revolution speed is greater than a predetermined revolution speed NEₜₕ. A revolution speed (for example, 2000 rpm or more) that was previously set as a revolution speed at which a time period during which a leakage of compressed air occurs is short and a drop in the in-cylinder pressure is of an ignorable level can be used as the predetermined revolution speed NEₜₕ. Note that, for example, a case of a fuel-cut operation when running at a high speed or a case where operation in a hybrid vehicle is switched from engine running to EV running or the like is assumed as a situation in which the aforementioned condition is established. By this means, since TDC correction can be performed using an in-cylinder pressure detection value in a case where the influence of compression leakage is of an ignorable level, the accuracy of the TDC correction can be improved.

Note that, the level of compression leakage is also related with the engine load (charging efficiency). That is, since the amount of compression leakage increases as the in-cylinder pressure increases, the amount of deviation from the actual TDC of Pₘₐₓ with respect to which the charging efficiency in the cylinder is high increases. Therefore, in the present embodiment the predetermined revolution speed NEₜₕ may be set in accordance with the size of the charging efficiency. FIG. 5 is a view for describing an example of setting the predetermined revolution speed NEₜₕ in accordance with the size of the charging efficiency. As shown in FIG. 5, preferably, the higher that the charging efficiency is, the larger the value to which the predetermined revolution speed NEₜₕ is set. By this means, even in a case where the charging efficiency is high, TDC correction can be performed using an in-cylinder pressure detection value that is detected in a case where the influence of compression leakage is of an ignorable level.

### Specific Processing in Embodiment 1

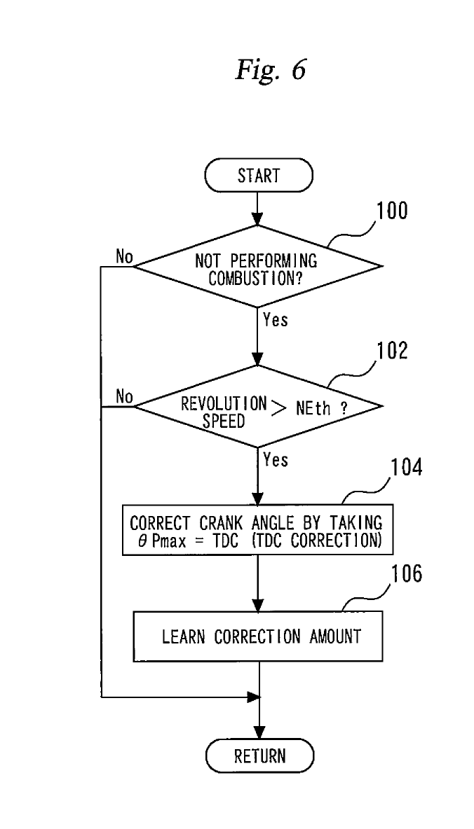

Next, specific processing to perform TDC correction that is executed in the system of the present embodiment will be described referring to a flowchart. FIG. 6 is a flowchart that illustrates a routine of Embodiment 1 of the present invention. In the routine illustrated in FIG. 6, first, it is determined whether or not the internal combustion engine 10 is not performing combustion (step 100). In this case, specifically, it is determined whether or not the current state is a state during cranking without fuel injection prior to starting of the internal combustion engine 10 or is a state during a fuel-cut operation after starting. If it is determined as a result that the state is not one in which the internal combustion engine 10 is not performing combustion, since a motoring waveform of the in-cylinder pressure cannot be detected, the present routine is promptly ended.

On the other hand, in the aforementioned step 100, if it is determined that the engine is not performing combustion, it is determined that it is possible to detect a motoring waveform of the in-cylinder pressure, and therefore the operation moves to the next step. In the next step, it is determined whether or not the engine revolution speed is greater than the predetermined revolution speed NEₜₕ (step 102). A revolution speed (for example, 2000 rpm or more) that was previously set as a revolution speed at which a time period during which a leakage of compressed air occurs is short and a drop in the in-cylinder pressure is ignorable is read in as the predetermined revolution speed NEₜₕ. Note that the predetermined revolution speed NEₜₕ may also be set based on the charging efficiency of the engine as described above.

If the result of the aforementioned step 102 indicates that the relation that the revolution speed>the predetermined revolution speed NEₜₕ does not hold, it is determined that the influence of an output deviation caused by compression leakage is superimposed on the in-cylinder pressure detection value, and therefore the present routine is promptly ended. In contrast, if the result of the aforementioned step 102 indicates that the relation that the revolution speed>the predetermined revolution speed NEₜₕ holds, it is determined that the influence of an output deviation is of a small enough level to be ignorable, and hence the operation moves to the next step. In the next step, TDC correction is performed (step 104). Specifically, the in-cylinder maximum pressure value Pₘₐₓ during motoring is identified using the in-cylinder pressure sensor 34. Next, a crank angle θPₘₐₓ (reference signal) corresponding to Pₘₐₓ is detected by the crank angle sensor 42. Subsequently, in accordance with the following equation (1), the crank angle is corrected so that the crank angle θ_{Pmax} becomes TDC.

Corrected crank angle (TDC)=θ_{Pmax}+crank angle correction amount (1)

(crank angle correction amount=TDC−θ_{Pmax})

Next, the crank angle correction amount calculated in the above step 104 is learned (step 106). Specifically, the relation between a signal of the crank angle sensor 42 and the crank angle (measured value) corresponding thereto is corrected using the crank angle correction amount calculated in the above step 104.

As described above, according to the in-cylinder pressure detection device of Embodiment 1, a detection signal of the in-cylinder pressure sensor 34 and a detection signal of the crank angle sensor 42 can be accurately synchronized by performing TDC correction with a high level of accuracy. By this means, it is possible to accurately detect the in-cylinder pressure that corresponds to the actual crank angle.

In this connection, in the above description of the in-cylinder pressure detection device of Embodiment 1, an example has been described in which the predetermined revolution speed NEₜₕ is set based on the charging efficiency. However, since there is a tendency for the influence of compression leakage to increase as the cooling water temperature decreases, a configuration may also be adopted in which the cooling water temperature is reflected as another parameter in the setting for the predetermined revolution speed NEₜₕ. More specifically, for example, such a configuration can be realized by previously storing a predetermined revolution speed NEₜₕ that corresponds to a charging efficiency and a cooling water temperature in a map or the like.

Note that, in the above described Embodiment 1, θ_{Pmax} corresponds to a “signal of the crank angle sensor at a time point at which a maximum in-cylinder pressure is detected by the in-cylinder pressure sensor” of the above described first aspect of the present invention. Further, in the above described Embodiment 1, “synchronization means” of the above described first aspect of the present invention is realized by the ECU 40 executing the processing in the above described steps 100 to 104.

### Embodiment 2

### Features of Embodiment 2

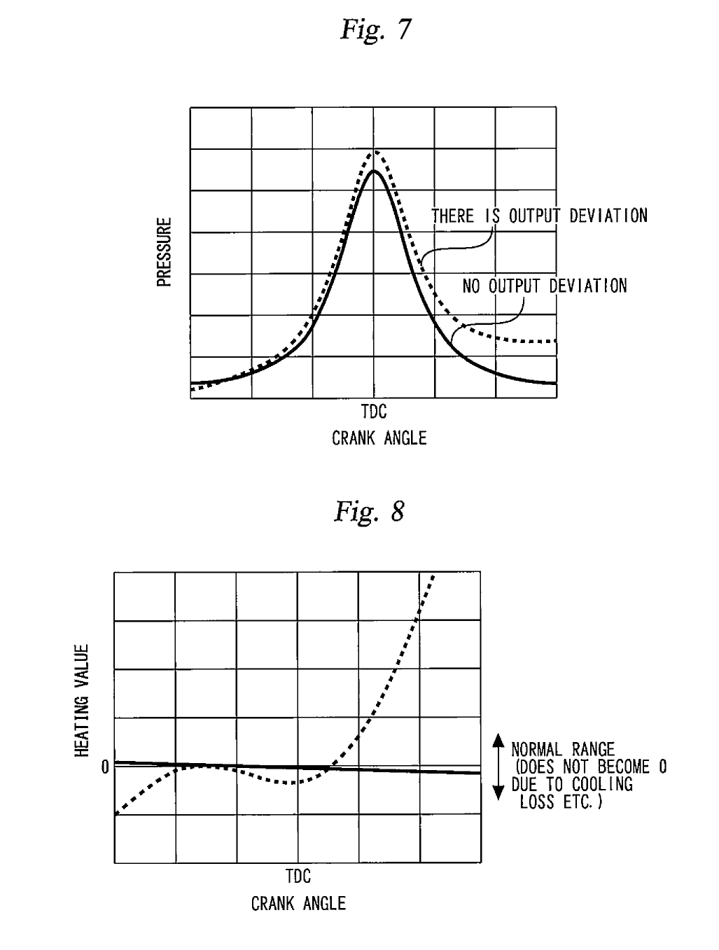

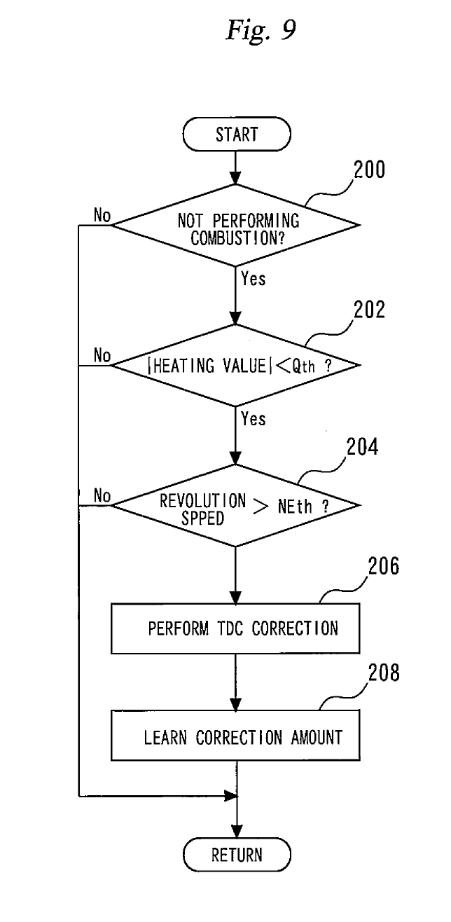

Next, Embodiment 2 of the present invention will be described referring to FIG. 7 to FIG. 10. The system of Embodiment 2 can be realized by using the hardware configuration illustrated in FIG. 1 and causing the ECU 40 to execute the routine shown in FIG. 9, described later.

In the system of the above described Embodiment 1, the relation between the crank angle signal and the actual crank angle is corrected using a detection value of the in-cylinder pressure sensor 34 at a time that combustion is not performed. However, for example, in a case such as when the engine transitioned from high-load operation to a fuel-cut operation, an output deviation that is caused by a temperature drift or a thermal strain caused by thermal expansion or contraction (hereunder, referred to simply as an “output deviation”) is superimposed on a detection value that is detected while the sensor temperature of the in-cylinder pressure sensor 34 is changing. FIG. 7 is a view that illustrates a difference in the in-cylinder pressure behavior that depends on the existence or non-existence of an output deviation. As shown in FIG. 7, in a case where an output deviation is occurring, a deviation arises in the pressure behavior relative to a case where an output deviation is not occurring. Such a case is unsuitable for performing TDC correction of the crank angle, since Pₘₐₓ cannot be accurately identified in such a case.

Therefore, in the system of the present embodiment, a configuration is adopted in which, after determining the existence or non-existence of an output deviation, in-cylinder pressure behavior in which an output deviation does not occur is selected and TDC correction is implemented. Specifically, the existence or non-existence of an output deviation can be determined based on the heating value behavior at a time that combustion is not performed. FIG. 8 is a view that illustrates heating value behavior that depends on the existence or non-existence of an output deviation. As shown in FIG. 8, at a time that combustion is not performed and an output deviation is not occurring, the heating value PV^{κ} is in a range in the vicinity of 0, while in contrast, the heating value increases to exceed the range in the vicinity of 0 in a case where an output deviation is occurring. Accordingly, it is possible to accurately determine the existence or non-existence of an output deviation by determining whether or not the heating value (absolute value) at a time that combustion is not performed is included in a predetermined range.

Thus, it is possible to increase the correction accuracy by, after having determined the existence or non-existence of an output deviation, performing TDC correction using the in-cylinder pressure behavior during a period in which an output deviation is not occurring.

### Specific Processing in Embodiment 2

Next, specific processing performed in the system of Embodiment 2 will be described. FIG. 9 is a flowchart that illustrates a routine that the ECU 40 executes in Embodiment 2 of the present invention. In the routine illustrated in FIG. 9, first, the ECU 40 determines whether or not the internal combustion engine 10 is not performing combustion (step 200). In this case, specifically, the same processing as in the above described step 100 is executed. If the ECU 40 determines as a result that the state is not one in which the internal combustion engine 10 is not performing combustion, since a motoring waveform of the in-cylinder pressure cannot be detected, the present routine is promptly ended.

In contrast, in the aforementioned step 200, if the ECU 40 determines that the engine is not performing combustion, the ECU 40 determines that it is possible to detect a motoring waveform of the in-cylinder pressure, and therefore the operation moves to the next step. In the next step, the ECU 40 determines whether or not an absolute value of the heating value is less than a predetermined value Qₜₕ (step 202). In this case, specifically, heating values are sequentially calculated during a period from the compression stroke to the expansion stroke while the engine is not performing combustion and are compared with the predetermined value Qₜₕ. A value that was previously stored as a threshold value for determining whether a heating value at a time that combustion is not being performed is normal is read in as the predetermined value Qₜₕ.

If it is determined as a result of the processing in the above described step 202 that the relation that |heating value|<Qₜₕ does not hold, the ECU 40 determines that TDC correction cannot be performed since an output deviation is occurring, and therefore the present routine is promptly ended. In contrast, if it is determined in the above described step 202 that the relation that |heating value|<Qₜₕ holds, the ECU 40 determines that TDC correction can be performed since an output deviation is not occurring, and therefore the operation moves to the next step. In the next step, the ECU 40 determines whether or not the engine revolution speed is greater than the predetermined revolution speed NEₜₕ (step 204). In this case, specifically, the same processing as in the above described step 102 is executed. If the result determined in step 204 is that the relation that revolution speed>predetermined revolution speed NEₜₕ does not hold, the ECU 40 determines that the influence of an output deviation caused by compression leakage is superimposed on the in-cylinder pressure detection value, and therefore the present routine is promptly ended.

On the other hand, in the aforementioned step 204, if it is determined that the relation that revolution speed>predetermined revolution speed NEₜₕ holds, the ECU 40 determines that the influence of an output deviation is of a level that is small enough to be ignorable, and therefore the operation moves to the next step. In the next step, TDC correction is performed (step 206). Next, a crank angle correction amount that was calculated in the aforementioned step 206 is learned (step 208). In this case, specifically, the same processing as in the above described steps 104 to 106 is executed.

As described in the foregoing, according to the in-cylinder pressure detection device of Embodiment 2, TDC correction of the crank angle is carried out in a case where an output deviation does not occur. By this means, since the relation between a detection signal of the in-cylinder pressure sensor 34 and a measured value of the crank angle can be effectively corrected, it is possible to accurately detect the in-cylinder pressure that corresponds to the actual crank angle.

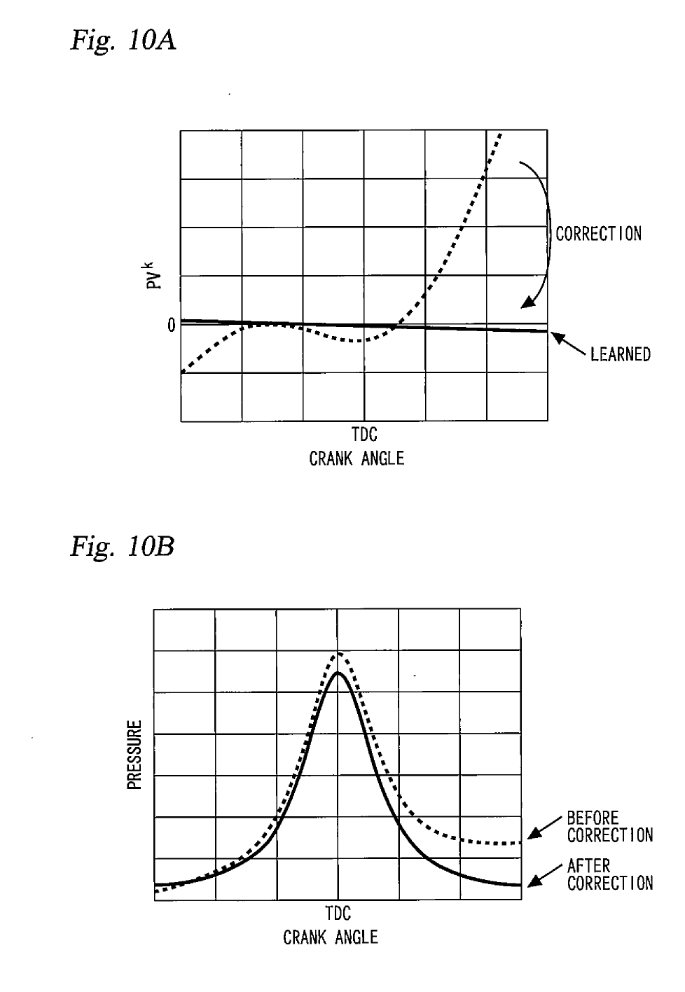

In this connection, according to the in-cylinder pressure detection device of Embodiment 2 that is described above, a configuration is adopted that performs crank angle correction in a case where an output deviation does not occur. However, a configuration may also be adopted that, even in a case where an output deviation is occurring, performs TDC correction of the crank angle after correcting the influence of the output deviation that is superimposed on the in-cylinder pressure behavior. FIG. 10 is a view for describing a method that corrects the influence of an output deviation. Note that, FIG. 10A illustrates PV^{κ} behavior before and after correction, and FIG. 10B illustrates in-cylinder pressure behavior before and after correction. As shown in FIG. 10A, first, the influence of an output deviation is corrected based on PV^{κ} before correction. Specifically, for example, the heating value behavior at a normal time is learned in advance, and correction is performed so that the heating value PV^{κ} after correction becomes the normal value that was learned. Further, the in-cylinder pressure behavior after correction that is illustrated in FIG. 10B can be calculated by dividing the heating value PV^{κ} after correction by V^{κ}. Note that, due to variations in cooling loss caused by the accumulation of deposits and the like, the heating value behavior at a normal time does not become 0 (zero). Consequently, in this case it is necessary to learn an amount of variation with respect to a waveform of a base heating value using an index for deposits or the like, and to learn the heating value behavior at a normal time in a manner that takes these influences into account. A technique for correcting the heating value behavior and converting the heating value behavior to in-cylinder pressure behavior is described in detail in, for example, Japanese Patent Laid-Open No. 2010-236534, and therefore a detailed description thereof is omitted herein.

Further, although in the in-cylinder pressure detection device of Embodiment 2 that is described above a configuration is adopted that identifies a reference crank angle θ_{Pmaxtgt} based on the engine revolution speed and the engine load factor, the reference crank angle θ_{Pmaxtgt} may also be identified using only either one of the engine revolution speed and the engine load factor. Further, there is a tendency for the influence of compression leakage to increase as the cooling water temperature decreases. Therefore, a configuration may also be adopted in which the cooling water temperature is reflected as another parameter in a calculation to identify the reference crank angle θ_{Pmaxtgt}. More specifically, for example, such a configuration can be realized by storing a crank angle θ_{Pmaxtgt} that corresponds to an engine revolution speed, an engine load factor and a cooling water temperature in advance in a map or the like. It is thereby possible to identify the reference crank angle θ_{Pmaxtgt} with greater accuracy.

In addition, in the above description of the in-cylinder pressure detection device of Embodiment 2, an example has been described in which the predetermined revolution speed NEₜₕ is set based on the engine load. However, since there is a tendency for the influence of compression leakage to increase as the cooling water temperature decreases, a configuration may also be adopted in which the cooling water temperature is reflected as another parameter in the setting for the predetermined revolution speed NEₜₕ. More specifically, for example, such a configuration can be realized by previously storing a predetermined revolution speed NEₜₕ that corresponds to an engine load and a cooling water temperature in a map or the like.

Note that, in the above described Embodiment 2, “determination means” of the above described fourth, fifth, and sixth aspects of the present inventions is realized by the ECU 40 executing the processing in the above described step 202.

### REFERENCE SIGNS LIST

10 Internal combustion engine
12 Piston
14 Cylinder head
16 Combustion chamber
18 Intake passage
20 Exhaust passage
22 Intake valve
24 Exhaust valve
26 Air cleaner
28 Throttle valve
30 Spark plug
32 Fuel injection valve
34 In-cylinder pressure sensor (CPS)
36 Intake valve timing control device (VVT)
40 ECU (electronic control unit)
42 Crank angle sensor

1. An in-cylinder pressure detection device for an internal combustion engine that includes an in-cylinder pressure sensor which is provided in a predetermined cylinder of the internal combustion engine and a crank angle sensor which outputs a signal which is synchronized with rotation of a crankshaft of the internal combustion engine, and that detects an in-cylinder pressure at a predetermined crank angle, comprising:
synchronization means for, in a case where an engine revolution speed is greater than 2000 rpm at a time of motoring or a time of a fuel-cut operation of the internal combustion engine, synchronizing a crank angle with a signal of the crank angle sensor so that a crank angle corresponding to a signal of the crank angle sensor at a time point at which a maximum in-cylinder pressure is detected by the in-cylinder pressure sensor becomes a TDC.

2. An in-cylinder pressure detection device for an internal combustion engine that includes an in-cylinder pressure sensor which is provided in a predetermined cylinder of the internal combustion engine and a crank angle sensor which outputs a signal which is synchronized with rotation of a crankshaft of the internal combustion engine, and that detects an in-cylinder pressure at a predetermined crank angle, comprising:
synchronization means for, in a case where an engine revolution speed is greater than a predetermined revolution speed at a time of motoring or a time of a fuel-cut operation of the internal combustion engine, synchronizing a crank angle with a signal of the crank angle sensor so that a crank angle corresponding to a signal of the crank angle sensor at a time point at which a maximum in-cylinder pressure is detected by the in-cylinder pressure sensor becomes a TDC, wherein
the synchronization means includes means for setting the predetermined revolution speed to a progressively larger value as a charging efficiency of the internal combustion engine increases.

3. The in-cylinder pressure detection device for an internal combustion engine according to claim 1, further comprising:
determination means for determining whether or not an output deviation is occurring in a detection value of the in-cylinder pressure sensor; and
restriction means for, in a case where it is determined that the output deviation is occurring, restricting an operation by the synchronization means.

4. The in-cylinder pressure detection device for an internal combustion engine according to claim 1, further comprising:
determination means for determining whether or not an output deviation is occurring in a detection value of the in-cylinder pressure sensor; and
correction means for, in a case where it is determined that the output deviation is occurring, correcting the output deviation;
wherein the synchronization means acquires a signal of the crank angle sensor at a time point at which a maximum in-cylinder pressure is detected using an in-cylinder pressure after correction by the correction means.

5. The in-cylinder pressure detection device for an internal combustion engine according to claim 3, wherein the determination means includes means for, in a case where an absolute value of a heating value is less than a predetermined value, determining that the output deviation is not occurring.

6. The in-cylinder pressure detection device for an internal combustion engine according to claim 2, further comprising:
determination means for determining whether or not an output deviation is occurring in a detection value of the in-cylinder pressure sensor; and
restriction means for, in a case where it is determined that the output deviation is occurring, restricting an operation by the synchronization means.

7. The in-cylinder pressure detection device for an internal combustion engine according to claim 2, further comprising:
determination means for determining whether or not an output deviation is occurring in a detection value of the in-cylinder pressure sensor; and
correction means for, in a case where it is determined that the output deviation is occurring, correcting the output deviation;
wherein the synchronization means acquires a signal of the crank angle sensor at a time point at which a maximum in-cylinder pressure is detected using an in-cylinder pressure after correction by the correction means.

8. The in-cylinder pressure detection device for an internal combustion engine according to claim 6, wherein the determination means includes means for, in a case where an absolute value of a heating value is less than a predetermined value, determining that the output deviation is not occurring.

9. An in-cylinder pressure detection device for an internal combustion engine that includes an in-cylinder pressure sensor which is provided in a predetermined cylinder of the internal combustion engine and a crank angle sensor which outputs a signal which is synchronized with rotation of a crankshaft of the internal combustion engine, and that detects an in-cylinder pressure at a predetermined crank angle, comprising:
engine revolution speed detecting means for detecting whether or not an engine revolution speed is greater than a predetermined revolution speed; and
synchronization means for, in a case where the engine revolution speed detecting means detects that the engine revolution speed is greater than the predetermined revolution speed at a time of motoring or a time of a fuel-cut operation of the internal combustion engine, synchronizing a crank angle with a signal of the crank angle sensor so that a crank angle corresponding to a signal of the crank angle sensor at a time point at which a maximum in-cylinder pressure is detected by the in-cylinder pressure sensor becomes a TDC.

10. The in-cylinder pressure detection device for an internal combustion engine according to claim 9, wherein the predetermined revolution speed is an engine revolution speed at which a drop in the in-cylinder pressure is of an ignorable level.

11. The in-cylinder pressure detection device for an internal combustion engine according to claim 10, wherein the predetermined revolution speed is 2000 rpm.

12. An internal combustion engine comprising:
an in-cylinder pressure sensor which is provided in a predetermined cylinder of the internal combustion engine;
a crank angle sensor which outputs a signal which is synchronized with rotation of a crankshaft of the internal combustion engine; and
a controller configured to detect an in-cylinder pressure at a predetermined crank angle based on outputs from the in-cylinder pressure sensor and the crank angle sensor, and having a control logic configured to, in a case where an engine revolution speed is greater than 2000 rpm at a time of motoring or a time of a fuel-cut operation of the internal combustion engine, synchronize a crank angle with a signal of the crank angle sensor so that a crank angle corresponding to a signal of the crank angle sensor at a time point at which a maximum in-cylinder pressure is detected by the in-cylinder pressure sensor becomes a TDC.

13. An internal combustion engine comprising:
an in-cylinder pressure sensor which is provided in a predetermined cylinder of the internal combustion engine;
a crank angle sensor which outputs a signal which is synchronized with rotation of a crankshaft of the internal combustion engine; and
a controller configured to detect an in-cylinder pressure at a predetermined crank angle based on outputs from the in-cylinder pressure sensor and the crank angle sensor, and having a control logic configured to:
(i) in a case where an engine revolution speed is greater than a predetermined revolution speed at a time of motoring or a time of a fuel-cut operation of the internal combustion engine, synchronize a crank angle with a signal of the crank angle sensor so that a crank angle corresponding to a signal of the crank angle sensor at a time point at which a maximum in-cylinder pressure is detected by the in-cylinder pressure sensor becomes a TDC, and
(ii) set the predetermined revolution speed to a progressively larger value as a charging efficiency of the internal combustion engine increases.

14. An internal combustion engine comprising:
an in-cylinder pressure sensor which is provided in a predetermined cylinder of the internal combustion engine;
a crank angle sensor which outputs a signal which is synchronized with rotation of a crankshaft of the internal combustion engine; and
a controller configured to detect an in-cylinder pressure at a predetermined crank angle based on outputs from the in-cylinder pressure sensor and the crank angle sensor, and having a control logic configured to:
(i) detect whether or not an engine revolution speed is greater than a predetermined revolution speed based on a signal outputted from the crank angle sensor, and
(ii) in a case where it is detected that the engine revolution speed is greater than the predetermined revolution speed at a time of motoring or a time of a fuel-cut operation of the internal combustion engine, synchronize a crank angle with a signal of the crank angle sensor so that a crank angle corresponding to a signal of the crank angle sensor at a time point at which a maximum in-cylinder pressure is detected by the in-cylinder pressure sensor becomes a TDC.
